(19) United States
(12) Patent Application Publication
(10) Pub. No.: US 2013/0312911 A1
(43) Pub. Date: Nov. 28, 2013

(54) WET-ETCHING EQUIPMENT AND ITS SUPPLYING DEVICE

(71) Applicant: UNIMICRON TECHNOLOGY CORPORATION, Taoyuan (TW)

(72) Inventors: Tzyy-Jang Tseng, Taoyuan (TW); Tsung-Yuan Chen, Taoyuan (TW)

(73) Assignee: UNIMICRON TECHNOLOGY CORPORATION, Taoyuan (TW)

(21) Appl. No.: 13/660,304

(22) Filed: Oct. 25, 2012

(30) Foreign Application Priority Data
May 23, 2012 (TW) 101118319

(51) Int. Cl. B05B 1/00; B05B 12/00

(52) U.S. Cl. 156/345.15; 239/589; 156/345.21

(57) ABSTRACT

A supplying device including a supplying part and an adjustment part is provided. The supplying part includes a run-through supplying path for transporting a fluid. The adjustment part includes a channel and one or more recovery paths adjacent to the channel. The supplying part is disposed in the channel to allow the fluid to flow out of the channel through the supplying part and to allow the recovery paths to suck a portion of the etching solution outputted from the channel in order to control the amount of output of the fluid. Wet-etching equipment including the supplying device is also provided.

### FIELD OF THE INVENTION

The present invention relates to etching equipment, and more, particularly, to wet-etching equipment and a supplying device thereof.

### BACKGROUND OF THE INVENTION

In current semiconductor manufacturing processes of a panel such as a wafer, a packaging substrate, a packaging structure, or a circuit board, an etching solution is used for cleansing any surface residue on the panel, such as copper residue, gel residue, resists and the like. During a typical cleansing process, the etching solution is first used to remove the surface residue, and then a cleansing solution (e.g. water) is used to wash off the etching solution on the panel, and finally the surface of the panel is dried.

FIGS. 1A and 1B are top and side views of a traditional circuit board 5 during an etching cleansing process, respectively. An etching equipment (not shown in the diagram) delivers an etching solution 3 to a plurality of nozzles 11 arranged in an array via pipes 10 to spray the etching solution 3 onto the circuit board 5 through the nozzles 11.

However, the traditional nozzles 11 are fixed in place, that is, the positions of the nozzles cannot be adjusted and the nozzles cannot be operated independent of one another. As a result, the nozzles 11 must be designed in such a way so as to spray the etching solution 3 in a wide range of area to prevent incomplete cleansing. Since the amount of spraying output by the etching solution 3 cannot be controlled, micro-etching or selectively etching on a certain area is not possible and thus, the surfaces of some small areas cannot be thoroughly cleansed, and selective processing with high-precision control cannot be performed to achieve diversity in product features. It is difficult to increase the granularity of the etching control.

Moreover, in the traditional wet-etching equipment, the pipes 10 and the nozzles 11 are distributed evenly. The positions of the pipes 10 and the nozzles 11 cannot be adjusted, and the nozzles 11 cannot be operated individually. Therefore, fine etching operations cannot be performed on a specific area of the circuit board 5. For example, micro-etching is not possible on a specific area, and surface residue cannot be properly removed from microscopic areas. Currently, the etching operations are carried out by the wet-etching equipment in continuous batches, therefore selective processing with high-precision control for product variations cannot be performed. It is thus difficult to increase the granularity of the etching control, which hinders the possibility for offering product diversity as well as decreases the yield of the products.

Thus, there is a need for a solution that overcomes the various shortcomings in the prior art as mentioned above.

### SUMMARY OF THE INVENTION

In light of the foregoing drawbacks, an objective of the present invention is to provide a supplying device, in which the periphery of a supplying part such as a nozzle is surrounded by an adjustment part. The adjustment part includes a channel and recovery paths adjacent to the channel. The supplying part is disposed within the channel for allowing the etching solution to be outputted from the channel and the recovery paths to suck a portion of the etching solution outputted from the channel, thereby reducing the output of the etching solution.

The above supplying device can be provided on a machine of the wet-etching equipment. The machine includes positioning parts on which the supplying parts are disposed for driving the supplying parts and the adjustment parts to move to required positions.

In addition, the machine includes a PLC system for controlling the operations of the positioning parts, the movement of the etching solution or the operations of the recovery paths.

The wet-etching equipment and a supplying device thereof in accordance with the present invention enable the adjustment part to control the amount of output of the sprayed etching solution using the design of the recovery paths, that is, to control the range of the sprayed etching solution in order to perform micro-etching or selective etching on specific areas. As a result, the surfaces of microscopic areas can be cleansed, and selecting processing with high-precision control can be carried out to offer diversity in product features, thereby improving the ability of fine etching of the wet-etching equipment and achieving high yield and high product diversity.

### BRIEF DESCRIPTION OF THE DRAWINGS

The present invention can be more fully understood by reading the following detailed description of the preferred embodiments, with reference made to the accompanying drawings, wherein:

FIG. 1A is a top schematic view illustrating a traditional circuit board during an etch-cleansing process;

FIG. 1B is a side schematic view illustrating the traditional circuit board during the etch-cleansing process;

FIG. 2A is a cross-sectional schematic view illustrating a supplying device in accordance with the present invention;

FIG. 2B is a top schematic view illustrating an adjustment part of the supplying device in accordance with the present invention; and

FIGS. 3A to 3C are top schematic views illustrating different embodiments of wet-etching equipment in accordance with the present invention.

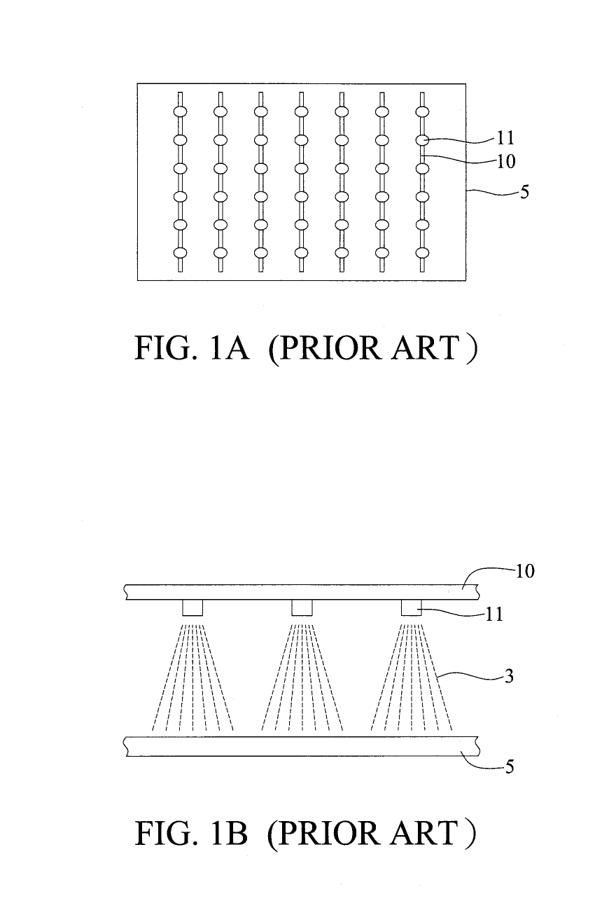

### DETAILED DESCRIPTION OF THE EMBODIMENTS

The present invention is described by the following specific embodiments. Those with ordinary skills in the arts can readily understand the other advantages and functions of the present invention after reading the disclosure of this specification.

It should be noted that the structures, proportions and sizes shown in the attached drawings are made to accompany the contents of the specification to facilitate understanding and readability of the present invention; the present invention is not limited as such.

Modifications on the structures, changes in relative proportions, and adjustments in sizes are considered to be within the scope of the technical contents disclosed by the present invention as long as they do not affect the effects and objectives achieved by the present invention. Meanwhile, terms such as ‘top’, ‘bottom’, ‘a’ and ‘an’ cited in the specification are provided for ease of understanding; the present invention is not limited as such. Changes or adjustments to relative relationships without substantially changing the technical contents should fall within the scope of the present invention

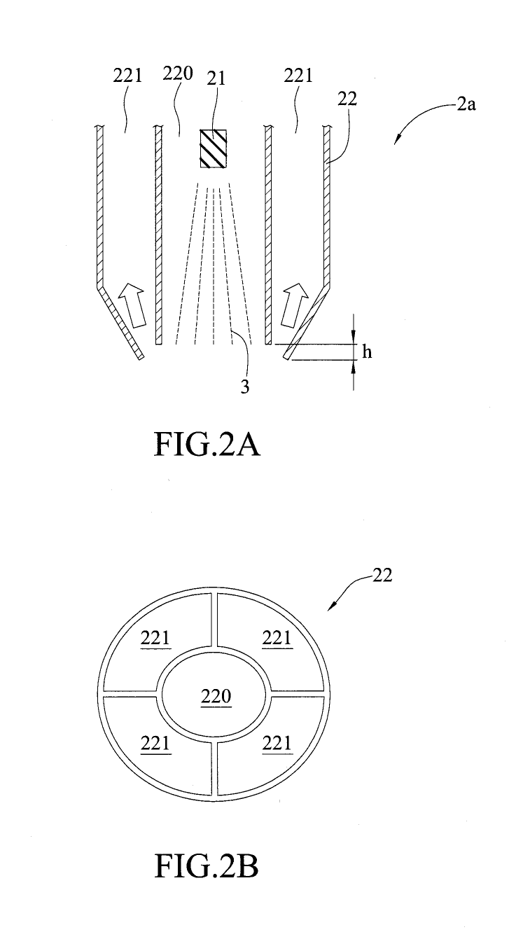

FIGS. 2A and 2B are schematic diagrams illustrating a supplying device 2a used for a wet-etching equipment in accordance with the present invention. As shown in FIG. 2A, the supplying device 2a includes a supplying part 21 and an adjustment part 22.

The supplying part 21 has a run-through supplying path (not shown in the diagram) for transporting fluid. In an embodiment, the supplying part 21 is a nozzle.

The adjustment part 22 has a channel 220 and recovery paths 221 adjacent to the channel 220. The supplying part 21 is disposed within the channel 220 to allow an etching solution 3 to flow through the supplying part 21 to be outputted from the channel 220. The recovery paths 221 suck a portion of etching solution 3 outputted from the channel 220 to reduce the output of the etching solution 3.

In an embodiment, the recovery paths 221 recover the etching solution 3 by siphon suction, as indicated by the direction of the arrows shown in FIG. 2A.

Furthermore, a height difference h exists between the bottom openings of the recovery paths 221 and the bottom opening of the channel 220, as shown in FIG. 2A. The bottom openings of the recovery paths 221 are at a lower level than that of the channel 220. That is, the bottom openings of the recovery paths 221 are positioned below the bottom opening of the channel 220 to facilitate suction of some of the etching solution 3 outputted by the channel 220.

In addition, the recovery paths 221 are disposed around the periphery of the channel 220, as shown in FIG. 2B, to improve the recovery rate of the recovery paths 221, in other words, to improve the accuracy of the micro-supply of the etching solution 3.

In the supplying device 2a of the present invention, the channel 220 is used to control an etched region, and the recovery paths 221 are used to recover some of the etching solution 3. The adjustment part 22 can control the amount of sprayed etching solution 3 and the range of the sprayed etching solution 3, so as to cleanse microscopic areas (e.g. point areas) and to perform selective processing of high-precision control to achieve diversity in product features, thereby achieving high-precision control.

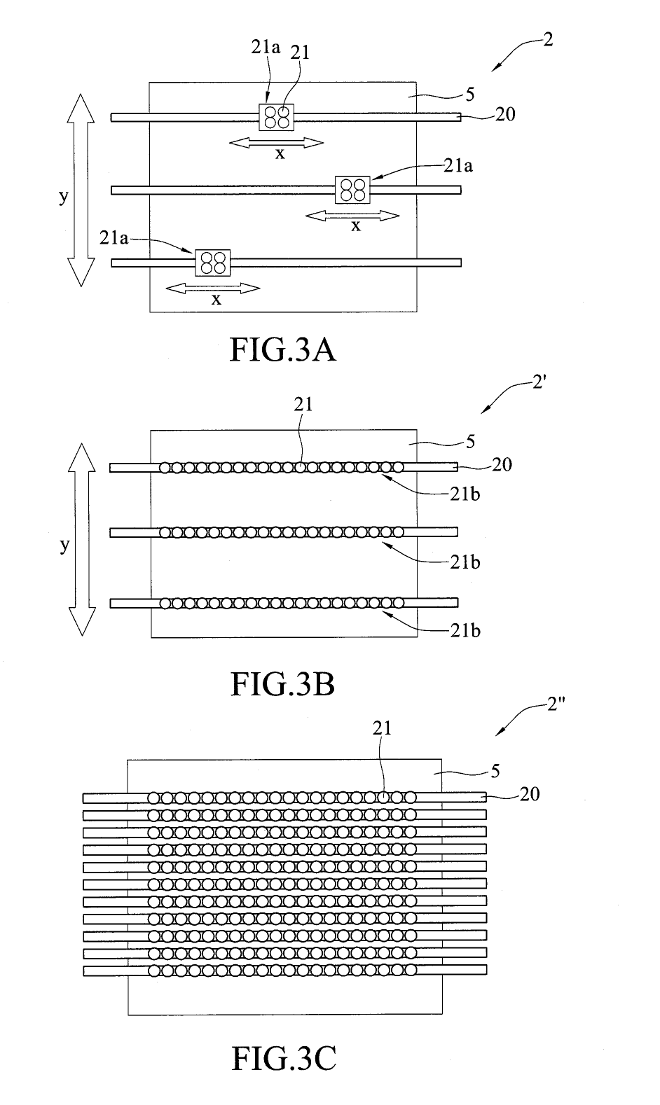

Referring to FIGS. 3A to 3C, wet-etching equipment 2, 2′ and 2″ including the supplying device 2a are shown. The supplying device 2a is placed on a machine (not shown).

The machine has a receiving space (not shown) for storing a fluid (e.g., the etching solution 3), and the supplying parts 21 are disposed on the machine. The supplying path is in communication with the receiving space of the machine so as to allow the etching solution 3 in the receiving space to flow out of the machine via the supplying path. The recovery paths of the adjustment parts 22 are also in communication with the receiving space of the machine so as to allow a portion of the etching solution 3 to be sucked back into the receiving space of the machine via the supplying parts 21 in a direction indicated by the arrows shown in FIG. 2A.

In an embodiment, the machine includes a programmable logic controller (PLC) system and positioning parts 20. The PLC system is used to control the etching cleansing operations, for example, the movement of the etching solution 3 or the operations of the recovery paths 221. The supplying parts 21 are placed on the positioning parts 20. The PLC system controls the positioning parts 20 to move the supplying parts 21 and the adjustment parts 22 to required positions.

Moreover, a plurality of supplying parts 21 are provided. At least two supplying parts 21 form a set of supplying units 21a or 21b as shown in FIGS. 3A and 3B, respectively. Alternatively, the supplying parts 21 are arranged in arrays to form high-density arrayed groups of etching nozzles.

The supplying unit 21a can be composed of several supplying parts 21 arranged in a square as shown in FIG. 3A. Alternatively, the supplying unit 21b can be composed of several supplying parts 21 arranged in a straight line as shown in FIG. 3B.

Moreover, the supplying parts 21 or the supplying units 21a and 21b can be moved by the positioning parts 20 vertically in y direction as shown in FIGS. 3A and 3B.

In addition, the positioning parts 20 can serve as tracks along which the supplying parts 21 or the supplying units 21a move laterally in x direction as shown in FIG. 3A.

With the PLC system, the wet-etching equipment 2, 2′ and 2″ in accordance with the present invention can operate individual supplying part 21 or supplying unit 21a or 21b and thus have the ability of selectively etching control, and fine regional etching operations on specific areas of the circuit board 5 can be performed.

Moreover, with the positioning parts 20, the supplying parts 21 or the supplying units 21a or 21b, the adjustment parts 22 can be moved to required positions, thus providing the ability of selectively etching control, and fine regional etching operations on specific areas of the circuit board 5 can also be performed.

Therefore, during batch continuous operations of the entire panel, movable (shown in FIGS. 3A and 3B) or multiple sets (shown in FIG. 3C) of wet-etching equipment 2, 2′ and 2″ can be used to etch-cleanse the circuit board 5, and perform selective processing with high-precision control to achieve diversity in product features, thereby improving the granularity of etch control. For example, after an initial etching operation, an optical examination is performed, and any areas (point areas) with remaining residue (e.g. copper residue) are subjected to a second etching process, eliminating the need to perform the etching process on the entire panel.

Furthermore, there are a variety of panels, such as wafers, packaging substrates or packaging structures. The present invention is not limited to circuit boards.

In addition, there can be numerous types of fluids in the receiving space of the machine. The present invention is not limited to etching solutions, but can be other types of fluids (e.g., water).

In summary, the wet-etching equipment and a supplying device thereof in accordance with the present invention enables the adjustment part to control the amount of output of the sprayed etching solution using the design of the recovery paths in order to perform micro-etching or selective etching, improving the ability of fine etching of the wet-etching equipment.

Moreover, with the positioning parts and the PLC system, etching operations on specific areas of each panel can be performed. During continuous batch operations of the entire panel, selecting processing with high-precision control can be carried out as appropriate, improving the granularity of the etching control, as well as offering product diversity and increased product yield.

The above embodiments are only used to illustrate the principles of the present invention, and they should not be construed as to limit the present invention in any way. The above embodiments can be modified by those with ordinary skill in the art without departing from the scope of the present invention as defined in the following appended claims.

What is claimed is:

1. A wet-etching equipment, comprising:
a machine including a receiving space for storing a fluid;
at least a supplying part provided on the machine including a run-through supplying path in communication with the receiving space of the machine to allow the fluid in the receiving space to flow out of the machine via the supplying path; and
an adjustment part including a channel and one or more recovery paths adjacent to the channel,
wherein the at least a supplying part is received in the channel and the fluid flowing through the at least a supplying part flows out of the channel.

2. The wet-etching equipment of claim 1, wherein the machine further includes one or more positioning parts on which the at least a supplying part is provided, the one or more positioning parts driving the at least a supplying part and the adjustment part to move to required positions.

3. The wet-etching equipment of claim 2, wherein the machine further includes a Programmable Logic Controller (PLC) system for controlling operations of the positioning parts.

4. The wet-etching equipment of claim 1, wherein the machine further includes a PLC system for controlling movement of the fluid.

5. The wet-etching equipment of claim 1, wherein the machine includes a PLC system for controlling operations of the one or more recovery paths.

6. The wet-etching equipment of claim 1, wherein the supplying part is a nozzle.

7. The wet-etching equipment of claim 1, wherein when the at least a supplying part are in plurality, at least two of which form a set of supplying unit.

8. The wet-etching equipment of claim 1, wherein the at least a supplying part includes a plurality of supplying parts arranged in arrays.

9. The wet-etching equipment of claim 1, wherein a height difference exists between bottom openings of the one or more recovery paths and a bottom opening of the channel.

10. The wet-etching equipment of claim 1, wherein the channel has a periphery surrounded by the one or more recovery paths.

11. A supplying device, comprising:
a supplying part including a run-through supplying path for transporting a fluid; and
an adjustment part including a channel and one or more recovery paths adjacent to the channel, the supplying part being disposed in the channel to allow the fluid to flow out of the channel through the supplying part.

12. The supplying device of claim 11, wherein the supplying part is a nozzle.

13. The supplying device of claim 11, wherein a height difference exists between bottom openings of the one or more recovery paths and a bottom opening of the channel.

14. The supplying device of claim 11, wherein the channel has a periphery surrounded by the recovery paths.
